(19) United States
(12) Patent Application Publication
(10) Pub. No.: US 2009/0169897 A1
(43) Pub. Date: Jul. 2, 2009

(54) BARRIER LAMINATE, BARRIER FILM SUBSTRATE, DEVICE AND OPTICAL COMPONENT

(76) Inventor: Yuya AGATA, Kanagawa (JP)

Correspondence Address: BIRCH STEWART KOLASCH & BIRCH, PO BOX 747, FALLS CHURCH, VA, 22040-0747, US

(21) Appl. No.: 12/343,991

(22) Filed: Dec. 24, 2008

(30) Foreign Application Priority Data
Dec. 27, 2007 (JP) 2007-337415
Feb. 25, 2008 (JP) 2008-043378

(51) Int. Cl. B32B 27/36; B32B 27/00; B32B 27/40; B32B 27/08; B32B 27/06

(52) U.S. Cl. 428/412; 428/500; 428/421; 428/424.4; 428/425.9; 428/473.5; 428/476.3; 428/474.4; 428/483; 428/480; 428/515

(57) ABSTRACT

A barrier laminate comprising at least one organic layer and at least one inorganic layer, wherein the organic layer comprises a cured resin having a degree of swelling with water of less than 0.8% or a cured product of an acrylate and/or a methacrylate having a water absorption of less than 1%. The laminate has high adhesiveness between the organic layer and the inorganic layer and has a low water vapor permeability.

### BACKGROUND OF THE INVENTION

1. Field of the Invention

The present invention relates to a barrier laminate excellent in the adhesiveness between the organic layer and the inorganic layer constituting it and having low moisture vapor permeability, and in particular to a barrier film substrate produced by providing the barrier laminate on a plastic film. Further, the invention relates to a device comprising the barrier laminate or the barrier film substrate, in particular to an electronic device and further to an organic EL (organic electroluminescent) device. The invention also relates to an optical component comprising the barrier film substrate.

2. Description of the Related Art

Heretofore, a barrier film fabricated by forming a thin metal oxide film of aluminum oxide, magnesium oxide, silicon oxide or the like on the surface of a plastic film is widely used for wrapping or packaging articles that require shielding from various gases such as water vapor or oxygen and for wrapping or packaging edibles, industrial articles and medicines for preventing them from being deteriorated.

Recently, in the field of liquid-crystal display devices and organic EL devices, plastic film substrates are being used in place of glass substrates that are heavy and readily cracked or broken. As applicable to a roll-to-roll system, plastic films are advantageous in point of cost. However, plastic films are problematic in that their water vapor-barrier capability is not good as compared with that of glass substrates. Therefore, when a plastic film is used in a liquid-crystal display device, then water vapor may penetrate into the liquid-crystal cell, thereby causing display failures.

For solving the problem, it is known to use a barrier film substrate produced by forming a water vapor barrier laminate on a plastic film. As such a barrier film substrate, known are one produced by depositing silicon oxide on a plastic film in a mode of vapor deposition (e.g., see JP-B 53-12953 (pp. 1-3)), and one produced by depositing aluminum oxide thereon (e.g., see JP-A 58-217344 (pp. 1-4)); and their barrier capability is on a level of 1 g/m²/day or so in terms of the water vapor permeability.

However, the substrate for use in devices such as organic EL devices is required to have a water vapor barrier capability on a higher level. As a means for satisfying the requirement, reported are a technique of employing an organic/inorganic barrier laminate produced by laminating an organic layer and an inorganic layer, thereby realizing a water vapor permeability of less than 0.1 g/m²/day (e.g., see JP-A 2003-335880 and JP-A 2003-335820), and a technique of realizing a more excellent water vapor barrier capability on a level of less than 0.01 g/m²/day in terms of water vapor permeability (see U.S. Pat. No. 6,413,645).

However, the present inventors have studied the organic/inorganic laminate-type barrier film substrates disclosed in the prior art references and have found that they have some problems in that (1) for use in devices such as organic EL devices, their barrier capability is not always satisfactory, and (2) the organic layer and the inorganic layer may be often delaminated owing to the mechanical stress given thereto or the inorganic layer may be broken owing to the volume change (by expansion or contraction) of the organic layer during pretreatment such as patterning or washing thereof necessary in using the substrate in devices such as organic EL devices. Accordingly, it is desired to develop an organic/inorganic barrier laminate and a barrier film substrate having a sufficiently low water vapor permeability and having good adhesiveness, and a device comprising any of them.

### SUMMARY OF THE INVENTION

A first object of the invention is to provide an organic/inorganic laminate-type barrier film substrate having a sufficiently low water vapor permeability, of which the barrier capability does not lower even after pretreatment such as washing thereof. A second object of the invention is to provide a device of good durability, comprising the barrier film substrate.

The present inventors have assiduously studied and, as a result, have clarified that the volume change of the organic layer greatly lower the barrier capability of the inorganic layer, and have found that, in a barrier laminate comprising an organic layer and an inorganic layer, when an acrylate and a methacrylate having a low water absorption are mainly used as the monomer for producing the polymer to form the organic layer, then the barrier capability reduction owing to the swelling of the formed organic layer can be prevented; and on the basis of this finding, the inventors have completed the present invention described in detail hereinunder.

The invention includes the following:

(1) A barrier laminate comprising at least one organic layer and at least one inorganic layer, wherein the organic layer comprises a cured resin having a degree of swelling with water of less than 0.8%.

(2) The barrier laminate of (1), wherein the cured resin is a cured product of an acrylate and/or a methacrylate.

(3) A barrier laminate comprising at least one organic layer and at least one inorganic layer, wherein the organic layer comprises a cured product of an acrylate and/or a methacrylate having a water absorption of less than 1%.

(4) A barrier laminate comprising at least one organic layer and at least one inorganic layer, wherein the organic layer comprises a cured product of an acrylate and/or a methacrylate having a water absorption of less than 0.5%.

(5) The barrier laminate of any one of (2) to (4), wherein the acrylate/and or methacrylate is a polyfluoroalkanediol diacrylate or a polyfluoroalkanediol dimethacrylate.

(6) The barrier laminate of any one of (1) to (5), wherein the inorganic layer has a density of at least 2.0.

(7) The barrier laminate of any one of (1) to (5), wherein the inorganic layer has a density of at least 2.5.

(8) A barrier film substrate produced by providing the barrier laminate of any one of (1) to (7) on a plastic film.

(9) A device comprising the barrier film substrate of (8) as the substrate thereof.

(10) A device sealed up with the barrier film substrate of (8).

(11) A device sealed up with the barrier laminate of any one of (1) to (7).

(12) The device of any one of (9) to (11), which is an electronic device.

(13) The device of any one of (9) to (11), which is an organic EL device.

(14) An optical component comprising the barrier film substrate of (8) as the substrate thereof.

In the barrier laminate of the invention, the organic layer and the inorganic layer have high adhesiveness to each other, and the invention can provide a barrier film substrate having a low water vapor permeability. The device comprising the barrier film substrate of the invention has good durability.

### BEST MODE FOR CARRYING OUT THE INVENTION

The barrier laminate, the barrier film substrate, the device and the optical component of the invention are described in detail herein under. The description made herein under is for some typical embodiments of the invention, to which, however, the invention should not be limited. In this description, the numerical range expressed by the wording “a number to another number” means the range that falls between the former number indicating the lowermost limit of the range and the latter number indicating the uppermost limit thereof.

### <Barrier Laminate>

The barrier laminate of the invention has at least one organic layer and at least one inorganic layer and is the laminate that the degree of swelling with water of the cured resin to constitute the organic layer is less than 0.8%, or the cured resin to constitute the organic layer is a cured product of an acrylate and/or a methacrylate having a water absorption of less than 1%. In particular, it is desirable that the degree of swelling with water of the cured resin to constitute the organic layer is less than 0.8%, and the cured resin to constitute the organic layer is a cured product of an acrylate and/or a methacrylate having a water absorption of less than 1%. Employing this constitution, the invention has made it possible to prevent the inorganic layer from being cracked, therefore improving the barrier capability of the laminate.

The degree of swelling of the organic layer in the invention is meant to indicate the volume increase (film thickness increase) of the organic layer left at 40° C. and 90% RH for 24 hours relative to the film volume (film thickness) of the organic layer at 25° C. and 50% RH (stationary state). The degree of swelling of the organic layer may be determined as follows: An organic layer having a predetermined film thickness formed on a substrate is left under the condition of 40° C. and 90% RH for 24 hours, and then its film thickness is measured optically or by the use of a step difference meter, and the increase thereof may be computed according to the following formula (1):

Degree of Swelling (%)=[(film thickness after left for 24 hours−film thickness in stationary state)/(film thickness in stationary state)]×100. (1)

Preferably, the degree of swelling of the layer is less than 0.8%, more preferably at most 0.5%.

The water absorption of the organic layer in the invention is meant to indicate the change after moisture control relative to the water content of the original dry sample, as expressed in terms of percentage; and the water content of each sample can be determined according to a Karl-Fischer moisture titration method or the like.

For preventing the organic layer from swelling, preferably, the organic layer has a low water absorption and its film swelling by moisture absorption is small. The curable monomer for use in the invention is preferably such that its cured product has a water absorption of less than 1%, more preferably less than 0.8%, even more preferably less than 0.5%.

In the barrier laminate of the invention, preferably, the adhesiveness between the organic layer and the inorganic layer adjacent thereto is such that, when the laminate is stored at 40° C. and 90% RH for 24 hours, and then tested in a cross-cut peeling method according to JIS (Japanese Industrial Standards) K5600-5-6 (ISO 2409), the adhesiveness level is from 80 to 100%, more preferably from 85 to 100%.

### (Inorganic Layer)

The inorganic layer is generally a thin film layer of a metal compound. For forming the inorganic layer, employable is any method capable of producing the intended thin film. For it, for example, suitable are a coating method, a sputtering method, a vacuum vapor deposition method, an ion plating method, a plasma CVD method and the like. Concretely, employable are the methods described in Japanese Patent No. 3400324, and JP-A 2002-322561 and 2002-361774.

Not specifically defined, the ingredients constituting the inorganic layer may be any ones satisfying the above-mentioned properties, for which, for example, usable are oxides, nitrides or oxinitrides of at least one metal selected from Si, Al, In, Sn, Zn, Ti, Cu, Ce, Ta and the like. Of those, preferred are oxides, nitrides or oxinitrides of a metal selected from Si, Al, In, Sn, Zn and Ti; more preferred are metal oxides, nitrides or oxinitrides with Si or Al. These may contain any other subsidiary element.

Not specifically defined, the thickness of the inorganic layer is preferably within a range of from 5 nm to 500 nm, more preferably from 10 nm to 200 nm, even more preferably from 50 nm to 150 nm. In case where the inorganic layer is too thick, its adhesiveness to the adjacent organic layer at their boundary may lower owing to the stress of the inorganic layer, or the barrier laminate provided on a plastic film may curl owing to the thick inorganic layer therein; but on the contrary, when the inorganic layer is too thin, it may be ineffective for fully exhibiting the barrier capability thereof.

Not specifically defined, the density of the inorganic layer is preferably at least 2.0, more preferably at least 2.5, even more preferably at least 3.0. When at least 2.0, the barrier capability of the laminate may be better. Heretofore, the film thickness is increased for enhancing the barrier capability of the film. However, as a result of the present inventors' investigations, it has been known that when the film density of the inorganic layer is increased, then the inorganic layer may be denser and may be therefore readily influenced by external stress given thereto, or that is, the inorganic layer is readily influenced by the degree of swelling of the organic layer. The inventors have further found that, owing to the swelling of the organic layer, the inorganic layer may be cracked or the organic layer and the inorganic layer may be readily delaminated at their interface. The inventors have investigated in detail the relationship between the degree of swelling of the organic layer and the film density of the inorganic layer, and as a result, have succeeded in solving the above-mentioned problems.

The uppermost limit of the film density is not specifically defined. For example, it may be at most 4.0.

The film density of the inorganic layer may be determined according to an X-ray reflectance measuring method, as described in detail in Examples give hereinunder.

Two or more inorganic layers mentioned above may be laminated. In this case, the layers may have the same composition or different compositions.

### (Organic Layer)

Preferably, the polymer to constitute the organic layer is produced by polymerization of a monomer mixture comprising an acrylate or a methacrylate as the main ingredient. The main ingredient as referred to herein is meant to indicate the polymerizable monomer of which the content is the largest of the polymerizable monomers constituting the organic layer; and in general, its content is generally at least 80% by mass of the monomer component.

In the invention, the degree of swelling with water of the cured resin to constitute the organic layer must be less than 0.8%, or the cured resin to constitute the organic layer is a cured product of an acrylate and/or a methacrylate having a water absorption of less than 1%. When the level oversteps the range, then the organic layer and the adjacent inorganic layer may be delaminated at their interface or the inorganic layer may be cracked thereby causing significant reduction in the barrier capability of the laminate.

The monomer that satisfies the above-mentioned requirements includes 1,6-hexanediol diacrylate, 1,9-nonanediol diacrylate, neopentyl glycol diacrylate, 2-butyl-2-ethyl-1,3-propanediol diacrylate, dimethyloldicyclodecane diacrylate, bisphenol A-EO adduct diacrylate, tripropylene glycol diacrylate, isobornyl acrylate, polyfluoroalkanediol diacrylate, polyfluoroalkanediol dimethacrylate and the like compounds, to which, however, the invention should not be limited. Of those, especially preferred are polyfluoroalkanediol diacrylate and polyfluoroalkanediol dimethacrylate as the water absorption of their cured products is low. Specific examples of polyfluoroalkanediol diacrylate and polyfluoroalkanediol dimethacrylate are mentioned below, to which, however, the invention should not be limited.

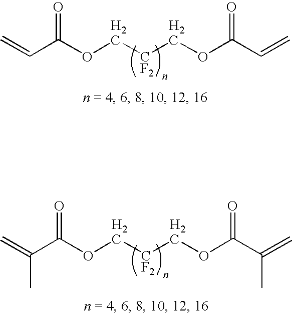

The curable monomer to constitute the organic layer may be a single monomer or a mixture of plural monomers. Needless-to-say, it may contain any other monomer than the above. Preferably, the proportion of the additional monomer is from 1 to 80% by mass, more preferably from 5 to 60% by mass, even more preferably from 10 to 30% by mass. The type of the monomer that may be mixed includes a monofunctional (meth)acrylate and a polyfunctional (meth)acrylate; and preferred is a 3- to 6-functional (meth)acrylate. (Meth)acrylate as referred to herein means one or both of acrylate and methacrylate. Further, a phosphate group or phosphoric acid group-containing monomer such as trisacryloyloxyethyl phosphate is favorably used herein, as enhancing the adhesiveness of the organic layer to inorganic layer.

In addition, the organic layer may contain, as mixed therein, a cured product of a (meth)acrylate having a structural unit of the following formula (1):

(Z-COO)ₙ-L (1)

In formula (1), Z represents any of the following (a) or (b); R² and R³ in the structures each independently represent a hydrogen atom or a methyl group; * indicates the position at which the structure bonds to the carbonyl group in formula (1); L represents an n-valent linking group; n indicates an integer of from 2 to 6; and n Z's may be the same or different, but at least one Z is represented by the following (a):

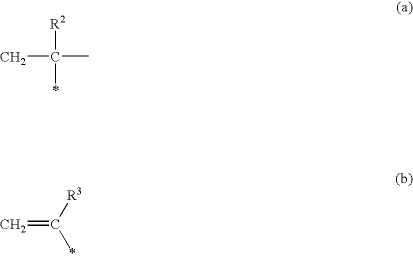

Preferably, L has from 3 to 18 carbon atoms, more preferably from 4 to 17, even more preferably from 5 to 16, still more preferably from 6 to 15 carbon atoms.

When n is 2, L is a divalent linking group. Examples of the divalent linking group include an alkylene group (e.g., 1,3-propylene group, 2,2-dimethyl-1,3-propylene group, 2-butyl-2-ethyl-1,3-propylene group, 1,6-hexylene group, 1,9-nonylene group, 1,12-dodecylene group, 1,16-hexadecylene group), an ether group, an imino group, a carbonyl group, and a divalent residue comprising any of those divalent groups bonding to each other in series (e.g., polyethyleneoxy group, polypropyleneoxy group, propionyloxyethylene group, butyroyloxypropylene group, caproyloxyethylene group, caproyloxybutylene group).

Of those, an alkylene group is preferred.

L may have a substituent. Examples of the substituent with which L may be substituted include an alkyl group (e.g., methyl group, ethyl group, butyl group), an aryl group (e.g., phenyl group), an amino group (e.g., amino group, a methylamino group, a dimethylamino group, a diethylamino group), an alkoxy group (e.g., methoxy group, ethoxy group, butoxy group, 2-ethylhexyloxy group), an acyl group (e.g., acetyl group, a benzoyl group, formyl group, pivaloyl group), an alkoxycarbonyl group (e.g., methoxycarbonyl group, ethoxycarbonyl group), a hydroxy group, a halogen atom (e.g., fluorine atom, chlorine atom, bromine atom, iodine atom), and a cyano group. Preferably, the substituent does not have an oxygen-containing functional group for the reasons mentioned below, and more preferred is an alkyl group.

Specifically, when n is 2, L is most preferably an alkylene group not having an oxygen-containing functional group. Employing the substituent makes it possible to lower the water vapor permeability of the laminate of the invention.

When n is 3, L is a trivalent linking group. Examples of the trivalent linking group include a trivalent residue to be derived from the above-mentioned divalent linking group by removing one hydrogen atom therefrom, or a trivalent residue to be derived from the above-mentioned divalent linking group by removing one hydrogen atom therefrom followed by substituting it with any of an alkylene group, an ether group, a carbonyl group and a divalent group comprising any of those divalent groups bonding to each other in series. Of those, preferred is a trivalent residue not having an oxygen-containing functional group, which is derived from an alkylene group by removing one hydrogen atom therefrom. Employing the residue makes it possible to lower the water vapor permeability of the laminate of the invention.

When n is 4 or more, L is a tetravalent or more polyvalent linking group. Examples of the tetravalent or more polyvalent linking group may be mentioned similarly to the above. Its preferred examples may also be mentioned similarly to the above. In particular, preferred is a tetravalent residue not having an oxygen-containing functional group, which is derived from an alkylene group by removing two hydrogen atoms therefrom. Employing the residue makes it possible to lower the water vapor permeability of the laminate of the invention.

Incorporating the above additional polymer to the organic layer is advantageous as readily improving the film quality of the organic layer.

As other examples of the polymer than the above, there are further mentioned polyester, methacrylic acid/maleic acid copolymer, polystyrene, transparent fluororesin, polyimide, fluoropolyimide, polyamide, polyamidimide, polyether imide, cellulose acylate, polyurethane, polyether ether ketone, polycarbonate, alicyclic polyolefin, polyarylate, polyether sulfone, polysulfone, fluorene ring-modified polycarbonate, alicyclic-modified polycarbonate, and fluorene ring-modified polyester. The content of the polymer not having the structural unit of formula (1) in the organic layer is preferably from 5 to 50% by mass, more preferably from 10 to 40% by mass, even more preferably from 20 to 35% by mass.

For forming the organic layer, employable are ordinary solution coating method and vacuum film formation method. The solution coating method includes, for example, a dip coating method, an air knife coating method, a curtain coating method, a roller coating method, a wire bar coating method, a gravure coating method, a slide coating method, and an extrusion coating method of using a hopper as in U.S. Pat. No. 2,681,294. In the solution coating method, the composition for the organic layer is easy to prepare and the latitude in selecting the curable material is broad, and therefore the method may enjoy the value added such as increased adhesiveness and surface smoothness.

Not specifically defined, the vacuum film formation method is preferably a flash vacuum evaporation method as in U.S. Pat. Nos. 4,842,893, 4,954,371 and 5,032,461. The compounds usable for vapor deposition in the vacuum film formation method are limited, and therefore, as compared with the solution coating method, the vacuum film formation lacks diversity in use; however, when the same formulation is used in the two, the vacuum film formation method may form a film having a lower water absorption, and therefore the method is favorable for preventing the inorganic layer from being cracked, which is one intended object of the invention.

The monomer polymerization method is not specifically defined, for which, for example, preferred is thermal polymerization, light (UV, visible ray) polymerization, electronic beam polymerization, plasma polymerization or their combination. Of those, especially preferred is photopolymerization. In photopolymerization, a photopolymerization initiator may be used. Examples of the photopolymerization initiator are Irgacure series (e.g., Irgacure 651, Irgacure 754, Irgacure 184, Irgacure 2959, Irgacure 907, Irgacure 369, Irgacure 379, Irgacure 819) sold by Ciba Specialty Chemicals; Darocur series (e.g., Darocur TPO, Darocure 1173); Quantacure PDO; Esacure series (e.g., Esacure TZM, Esacure TZT) sold by Sartomer. Preferably, the monomer polymerization is attained after the monomer mixture is disposed on a support.

The light for irradiation is generally UV light from high-pressure mercy lamp or low-pressure mercy lamp. The irradiation energy is preferably at least 0.5 J/cm², more preferably at least 2 J/cm². Since acrylate and methacrylate receive polymerization inhibition by oxygen in air, it is desirable that the oxygen concentration or the oxygen partial pressure during the monomer polymerization is reduced. In case where the oxygen concentration in polymerization is lowered by a nitrogen purging method, the oxygen concentration is preferably at most 2%, more preferably at most 0.5%. In case where the oxygen partial pressure in polymerization is lowered by a pressure reduction method, the total pressure is preferably at most 1000 Pa, more preferably at most 100 Pa. Especially preferred is UV polymerization with energy irradiation of at least 2 J/cm² under a reduced pressure condition of at most 100 Pa.

The thickness of the organic layer is not specifically defined. However, when too thin, the layer could not be uniform; but when too thick, the layer may be cracked and its barrier capability may lower. From these viewpoints, the thickness of the organic layer is preferably from 100 nm to 3000 nm, more preferably from 500 nm to 2000 nm. When the organic layer is thicker, water vapor transmission through it may be lower; but when the layer is too thick, then its volume expansion in moisture absorption may be large with the result that the inorganic layer may be cracked or the organic layer and the inorganic layer may be readily delaminated at their interface.

Especially in the invention, the thickness of the inorganic layer is preferably from 10 nm to 200 nm, more preferably from 50 nm to 150 nm, and the thickness of the organic layer is preferably so controlled as to fall within the above range, whereby the invention may exhibit the above-mentioned effect more remarkably.

### (Lamination of Organic Layer and Inorganic Layer)

The organic layer and the inorganic layer may be laminated by repeated film formation to form the organic layer and the inorganic layer in a desired layer constitution. In case where the inorganic layer is formed according to a vacuum film formation method such as sputtering method, vacuum vapor deposition method, ion plating method or plasma CVD method, then it is desirable that the organic layer is also formed according to a vacuum film formation method such as the above-mentioned flash vapor deposition method. While the barrier laminate is formed, it is desirable that the organic layer and the inorganic layer are laminated all the time in a vacuum of at most 100 Pa, not restoring the pressure to an atmospheric pressure during the film formation. More preferably, the pressure is at most 10 Pa, even more preferably at most 1 Pa. When the organic layer and the inorganic layer are laminated, the organic layer may be first formed on the support and then the inorganic layer may be formed thereon; and preferably, the organic layer is first formed on the support.

### (Constitution of Barrier Laminate)

The barrier laminate may be installed on any side of a plastic film; however, when the plastic film has amat gent layer, the barrier laminate is preferably installed on the side opposite to the side of the mat agent layer. The barrier laminate may be laminated on the plastic film in such a manner that the inorganic layer and the organic layer are laminated in that order from the side of the plastic film, or the organic layer and the inorganic layer are in that order from it. The uppermost layer of the barrier laminate may be either the inorganic layer or the organic layer. The barrier laminate may additionally have a functional layer formed thereon.

### Use of Barrier Laminate:

In general, the barrier laminate of the invention is formed on a support. Selecting the support, the barrier laminate may have various applications. The support includes a plastic film, as well as various devices, optical components, etc. Concretely, the barrier laminate of the invention may be used as a barrier layer of a barrier film substrate. The barrier laminate and the barrier film substrate of the invention may be used for sealing up devices that require gas-barrier performance. The barrier laminate and the barrier film substrate of the invention may be applied to optical components. These are described in detail hereinunder.

### <Barrier Film Substrate>

The barrier film substrate comprises a plastic film and a barrier laminate formed on the substrate film. In the barrier film substrate, the barrier laminate of the invention may be provided only one surface of the plastic film, or may be provided on both surfaces thereof. The barrier laminate of the invention may be laminated in an order of the inorganic layer and the organic layer from the side of the plastic film; or may be laminated in an order of the organic layer and the inorganic layer from it. The uppermost layer of the laminate of the invention may be the inorganic layer or the organic layer.

The barrier film substrate of the invention is a film substrate having a barrier layer that functions to shield oxygen, moisture, nitrogen oxide, sulfur oxide, ozone and others in air.

Not specifically defined, the number of the layers that constitute the barrier film substrate may be typically from 2 layers to 30 layers, more preferably from 3 layers to 20 layers.

The barrier film substrate may have any other constitutive components (e.g., functional layers such as easily-adhesive layer) in addition to the barrier laminate and the plastic film. The functional layer may be disposed on the barrier laminate, or between the barrier laminate and the plastic film, or on the side (back) of the plastic film not coated with the barrier laminate.

### (Plastic Film)

In the barrier film substrate of the invention, the substrate film is generally a plastic film. Not specifically defined in point of the material and the thickness thereof, the plastic film usable herein may be any one capable of supporting the laminate of the organic layer and the inorganic layer; and it may be suitably selected depending on the use and the object thereof. Concretely, the plastic film includes thermoplastic resins such as polyester resin, methacryl resin, methacrylic acid-maleic anhydride copolymer, polystyrene resin, transparent fluororesin, polyimide, fluoropolyimide resin, polyamide resin, polyamidimide resin, polyetherimide resin, cellulose acylate resin, polyurethane resin, polyether ether ketone resin, polycarbonate resin, alicyclic polyolefin resin, polyarylate resin, polyether sulfone resin, polysulfone resin, cycloolefin copolymer, fluorene ring-modified polycarbonate resin, alicyclic-modified polycarbonate resin, fluorene ring-modified polyester resin, acryloyl compound, etc.

In case where the barrier film substrate of the invention is used as a substrate of a device such as an organic EL device to be mentioned hereinunder, it is desirable that the plastic film is formed of a heat-resistant material. Concretely, the plastic film is preferably formed of a heat-resistant transparent material having a glass transition temperature (Tg) of not lower than 100° C. and/or a linear thermal expansion coefficient of at most 40 ppm/° C. Tg and the linear expansion coefficient may be controlled by the additives to the material. The thermoplastic resin of the type includes, for example, polyethylene naphthalate (PEN: 120° C.), polycarbonate (PC: 140° C.), alicyclic polyolefin (e.g., Nippon Zeon's Zeonoa 1600: 160° C.), polyarylate (PAr: 210° C.), polyether sulfone (PES: 220° C.), polysulfone (PSF: 190° C.), cycloolefin copolymer (COC, compound described in JP-A 2001-150584: 162° C.), polyimide (e.g., Mitsubishi Gas Chemical's Neoprim: 260° C.), fluorene ring-modified polycarbonate (BCF-PC, compound described in JP-A 2000-227603: 225° C.), alicyclic-modified polycarbonate (IP-PC, compound described in JP-A 2000-227603: 205° C.), acryloyl compound (compound described in JP-A2002-80616: 300° C. or more) (the parenthesized data are Tg). In particular, for high transparency, use of alicyclic polyolefin and the like is preferred.

Since the barrier film substrate of the invention is usable in devices such as organic EL devices, the plastic film is transparent, or that is, its light transmittance is generally at least 80%, preferably at least 85%, more preferably at least 90%. The light transmittance may be measured according to the method described in JIS-K7105. Concretely, using an integrating sphere-type light transmittance meter, a whole light transmittance and a quantity of scattered light are measured, and the diffusive transmittance is subtracted from the whole transmittance to obtain the intended light transmittance of the sample.

Even when the barrier film substrate of the invention is used in displays, it does not always require transparency in a case where it is not disposed on the viewers' side. Accordingly in such a case, a nontransparent material may be used for the plastic film. The nontransparent material includes, for example, polyimide, polyacrylonitrile, known liquid-crystal polymer.

Not specifically defined, the thickness of the plastic film for use in the barrier film substrate of the invention may be suitably selected depending on its use. Typically, the thickness may be from 1 to 800 μm, preferably from 10 to 200 μm. The plastic film may have a functional layer such as a transparent conductive layer, a primer layer, etc. The functional layer is described in detail in JP-A 2006-289627, paragraphs [0036] to [0038]. Examples of other functional layers than those are a mat agent layer, a protective layer, an antistatic layer, a planarizing layer, an adhesiveness improving layer, a light shielding layer, an antireflection layer, a hard coat layer, a stress relaxing layer, an antifogging layer, an anti-soiling layer, a printable layer, an easily-adhesive layer, etc.

### (Mat Agent Layer)

The barrier film substrate of the invention may have a mat agent layer. Preferably, the barrier film substrate of the invention has the barrier laminate on at least one side of the plastic film and has a mat agent layer on the other side thereof. The barrier film substrate of the invention may have at least one barrier laminate on one side of the plastic film and may have a mat agent layer on it. Preferably, this has the barrier laminate also on the other side thereof.

The mat agent for use in the invention preferably comprises inorganic or organic fine particles. Concretely, it comprises inorganic particles of silicon dioxide (SiO₂), titanium dioxide (TiO₂), calcium carbonate, magnesium carbonate or the like, or organic particles of polymethyl methacrylate, cellulose acetate propionate, polystyrene or the like. The method for forming the mat agent layer is not specifically defined. For example, the layer may be formed according to a coating method, such as a dipping method, an air knife coating method, a curtain coating method, a roller coating method, a wire bar coating method, a gravure coating method, or a slide coating method. The order of forming the mat agent layer and the barrier laminate to be provided on the opposite side is not specifically defined. Preferably, the barrier laminate is first formed on one side, and then the mat agent layer is formed on the opposite side. For example, one preferred embodiment comprises forming the barrier laminate on one side of a plastic film, then forming a mat agent layer thereon, and thereafter forming the barrier laminate on the other side of the plastic film. The thickness of the mat agent layer is preferably from 100 nm to 800 nm, more preferably from 200 nm to 500 nm.

The water vapor permeability of the barrier film substrate of the invention at 40° C. and a relative humidity of 90% is preferably at most 0.01 g/m²·day, more preferably at most 0.005 g/m²·day, even more preferably at most 0.001 g/m²·day.

### <Device>

The barrier laminate and the barrier film substrate of the invention are favorably used for devices that are deteriorated by the chemical components in air (e.g., oxygen, water, nitrogen oxide, sulfur oxide, ozone). Examples of the devices are, for example, organic EL devices, liquid-crystal display devices, thin-film transistors, touch panels, electronic papers, solar cells, and other electronic devices. More preferred are organic EL devices.

The barrier laminate of the invention may be used for film-sealing of devices. Specifically, this is a method of providing a barrier laminate of the invention on the surface of a device serving as a support by itself. Before providing the barrier laminate, the device may be covered with a protective layer.

The barrier film substrate of the invention may be used as a substrate of a device or as a film for sealing up a device according to a solid sealing method. The solid sealing method comprises forming a protective layer on a device, then forming an adhesive layer and a barrier film substrate as laminated thereon, and curing it. Not specifically defined, the adhesive may be a thermosetting epoxy resin, a photocurable acrylate resin, etc.

### (Organic EL Device)

Examples of an organic EL device with a barrier film substrate are described in detail in JP-A 2007-30387.

### (Liquid-Crystal Display Device)

A reflection-type liquid-crystal display device has a constitution of a lower substrate, a reflection electrode, a lower alignment film, a liquid-crystal layer, an upper alignment film, a transparent electrode, an upper substrate, a λ/4 plate and a polarizing film, formed in that order from the bottom. In this, the barrier film substrate of the invention may be used as the transparent electrode substrate and the upper substrate. In color displays, it is desirable that a color filter layer is additionally provided between the reflection electrode and the lower alignment film, or between the upper alignment film and the transparent electrode. A transmission-type liquid-crystal display device has a constitution of a backlight, a polarizer, a λ/4 plate, a lower transparent electrode, a lower alignment film, a liquid-crystal layer, an upper alignment film, an upper transparent electrode, an upper substrate, a λ/4 plate and a polarizing film, formed in that order from the bottom. In this, the barrier film substrate of the invention may be used as the upper transparent electrode and the upper substrate. In color displays, it is desirable that a color filter layer is additionally provided between the lower transparent electrode and the lower alignment film, or between the upper alignment film and the transparent electrode. Not specifically defined, the type of the liquid-crystal cell is preferably a TN (twisted nematic) type, an STN (super-twisted nematic) type, a HAN (hybrid aligned nematic) type, a VA (vertically alignment) type, an ECB (electrically controlled birefringence) type, an OCB (optically compensatory bend) type, a CPA (continuous pinwheel alignment) type, or an IPS (in-plane switching) type.

### (Others)

Other applications of the invention are thin-film transistors as in JP-T 10-512104, touch panels as in JP-A 5-127822, 2002-48913, electronic papers as in JP-A 2000-98326, and solar cells as in Japanese Patent Application No.7-160334.

### <Optical Component>

An example of the optical component that comprises the barrier film substrate of the invention is a circular polarizer.

In case where the barrier film substrate of the invention is combined with a circular polarizer in its use, it is desirable that the barrier layer side (on which a laminate containing at least one inorganic layer and at least one organic layer is formed) of the barrier film substrate faces the inside of the cell, and is disposed in the innermost site (adjacent to the device). In this case, the barrier film substrate is disposed more inside the cell than the circular polarizer, and therefore the retardation of the barrier film substrate is an important factor. In case where the barrier film substrate is used in the manner as above, preferred is any of the following embodiments: (1) The barrier film substrate comprising a substrate film having a retardation of at most 10 nm is laminated with a circular polarizer (¼ wavelength plate+(½ wavelength plate)+linear polarizer); or (2) the barrier film substrate comprising a substrate film having a retardation of from 100 nm to 180 nm, which is usable as a ¼ wavelength plate, is combined with a linear polarizer.

The substrate film having a retardation of at most 10 nm includes cellulose triacetate (FUJIFILM's Fujitac), polycarbonate (Teijin Chemical's Pureace, Kaneka's Elmec), cycloolefin copolymer (JSR's Arton, Nippon Zeon's Zeonoa), cycloolefin copolymer (Mitsui Chemical's Apel (pellets), Polyplastic's Topas (pellets)), polyarylate (Unitika's U100 (pellets)), transparent polyimide (Mitsubishi Gas Chemical's Neoprim), etc.

As the ¼ wavelength plate, usable is a film produced by suitably stretching the above-mentioned film to have a desired retardation.

### EXAMPLES

The characteristics of the invention are described more concretely with reference to the following Examples. In the following Examples, the material used, its amount and the ratio, the details of the treatment and the treatment process may be suitably modified or changed not overstepping the sprit and the scope of the invention. Accordingly, the invention should not be limitatively interpreted by the Examples mentioned below.

### 1. Determination of Degree of Swelling of Organic Layer:

On a hydrophobicated glass sheet, a mixture a monomer shown in Table 1 (20 g) and a UV polymerization initiator (Ciba Speciality Chemicals' trade name, Ciba Irgacure 907) (0.6 g) was applied, using a wire bar. This was put into a chamber having an oxygen concentration of 0.45% after nitrogen purging, and cured therein through irradiation with UV light from a high-pressure mercury lamp (integrated radiation, about 2 J/cm²), thereby forming an organic layer having a thickness of about 6 μm. The organic layer stored under a controlled condition at 25° C. and 50% RH for 24 hours, and then the thickness of the organic layer was measured with a step difference meter. This was further left under a constant temperature/humidity condition at 40° C. and 90% RH for 24 hours, and the thickness of the organic layer was measured with a step difference meter. According to the above-mentioned formula (1), the organic layer thickness increase was computed, and the value is the degree of swelling of the organic layer.

### 2. Determination of Water Absorption of Organic Layer:

On a hydrophobicated glass sheet, a mixture a monomer shown in Table 1 (20 g) and a UV polymerization initiator (Ciba Speciality Chemicals' trade name, Ciba Irgacure 907) (0.6 g) was applied, using a wire bar. This was put into a chamber having an oxygen concentration of 0.45% after nitrogen purging, and cured therein through irradiation with UV light from a high-pressure mercury lamp (integrated radiation, about 2 J/cm²), thereby forming an organic layer having a thickness of about 20 μm. The cured organic layer was peeled from the glass sheet, then cut into a piece having a size of 3 cm×10 cm, this was dried overnight in a vacuum desiccator under 1×10⁻³ Torr, and its water content was measured according to a Karl-Fischer method. On the other hand, this was conditioned at 25° C. and 60% RH for 3 days, and its water content was measured. From the data, the water absorption of the organic layer was computed. The data of the water absorption of the tested samples are shown in Table 1. The Karl-Fischer method is based on the description of JIS (Japanese Industrial Standards) K0113.

### 3. Production of Barrier Film Substrate (1):

A polyethylene naphthalate film (Teijin DuPont's trade name, Teonex Q65FA) was cut into a piece of 20 cm square; and a barrier laminate was formed on the smooth face side thereof according to the process mentioned below, thereby preparing barrier film substrate samples 1 to 4 of the invention and comparative barrier film substrate samples 5 to 7. These were tested and evaluated.

### (3-1) Formation of First Organic Layer:

On the smooth surface of a polyethylene naphthalate film, a mixture solution of a monomer shown in Table 1 (20 g), a UV polymerization initiator (Ciba Speciality Chemicals' trade name, Ciba Irgacure 907) (0.6 g) and 2-butanone (90 g) was applied, using a wire bar, so as to form a liquid layer having a thickness of 15 μm. This was dried at room temperature for 2 hours, then put into a chamber having an oxygen concentration of 0.45% after nitrogen purging, and the organic layer was cured therein through irradiation with UV light from a high-pressure mercury lamp (integrated radiation, about 2 J/cm²). The thickness of the layer formed was 1500 nm±200 nm.

### (3-2) Formation of First Inorganic Layer:

Using a sputtering device, a first inorganic layer (aluminum oxide) was formed on the first organic layer formed on the plastic film. Aluminum was used as the target; argon was used as the discharge gas; and oxygen was used as the reaction gas. The film formation pressure was 0.1 Pa; and the ultimate film thickness was 100 nm. The film density of the formed inorganic layer was measured according to an X-ray reflectance measuring method, and was 3.1.

### (3-3) Determination of Adhesiveness:

According to a cross-cut peeling method based on JIS (Japanese Industrial Standards) K5600-5-6 (ISO2409), the barrier film substrate that had been stored at 40° C. and 90% RH for 24 hours was analyzed for the adhesiveness between the organic layer and the inorganic layer. The tested sample was evaluated based on the ratio of the area of the film not broken in the test (percentage), and the result is shown in Table 1. The samples having a larger value have better adhesiveness.

### (3-4) Determination of Water Vapor Permeability:

A metal Ca was deposited on the barrier film substrate, and the film and a glass substrate were sealed up with a commercial organic EL sealant with the deposited face thereof kept inside, thereby preparing a sample to be tested. Next, the sample is kept under a controlled condition of 40° C. and 90% RH, and its water vapor permeability was determined from the optical density change of the metal Ca on the barrier film substrate (owing to hydroxylation or oxidation of Ca, the metallic gloss of the surface reduces and the surface is thereby discolored). The result is shown in Table 1.

### (3-5) Evaluation:

The degree of swelling of the organic layer of the barrier film substrate samples 1 to 4 of the invention was low. On the other hand, the degree of swelling of the organic layer of the comparative barrier film substrate samples 5 to 7 was higher than that of the samples of the invention. The samples of the invention and the comparative samples are compared with each other in point of the adhesiveness between the organic layer and the inorganic layer. As a result, the barrier film substrate samples of the invention had excellent adhesiveness even when left under high-humidity condition; and the water vapor permeability of the samples of the invention was lower than that of the comparative samples.

TABLE 1

| | | | | | Water | |
|---|---|---|---|---|---|---|
| | | Degree of | Water | Adhesive- | Vapor | |
| Sample | | Swelling | Absorption | ness | Permeability | |
| No. | Monomer | (%) | (%) | (%) | (g/m²/day) | Remarks |
| 1 | 1,9-nonanediol diacrylate | 0.74 | 0.34 | 80 | 0.006 | the |
| | | | | | | invention |
| 2 | 2-butyl-2-ethyl-1,3- | 0.51 | 0.29 | 85 | 0.004 | the |
| | propanediol diacrylate | | | | | invention |
| 3 | 1,9-nonanediol | 0.68 | 0.35 | 100 | 0.001 | the |
| | diacrylate/trisacryloyl- | | | | | invention |
| | oxyethyl phosphate = 3/1 | | | | | |
| 4 | monomer (A) mentioned below | 0.44 | 0.25 | 100 | 0.0008 | the |
| | | | | | | invention |
| 5 | dimethyloltricyclodecane | 0.95 | 0.63 | 75 | 0.008 | comparative |
| | diacrylate | | | | | sample |
| 6 | neopentyl glycol-modified | 1.56 | 1.26 | 25 | 0.02 | comparative |
| | trimethylolpropane | | | | | sample |
| | diacrylate | | | | | |
| 7 | trisacryloyloxyethyl | 2.42 | 1.81 | 100 | 0.02 | comparative |
| | phosphate | | | | | sample |

Monomer (A)

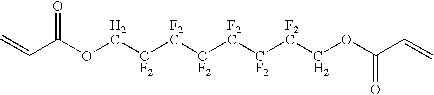

### 4. Production of Barrier Film Substrate (2):

Barrier film substrates each having one organic layer and one inorganic layer were produced in the same manner as in the above (1), in which, however, a different substrate film was used in place of the polyethylene naphthalate film used in (1), in order to evaluate barrier capability. The substrate films used herein are cycloolefin polymer film (COP film, Nippon Zeon's trade name, Zeonoa ZF-16), transparent polyimide film (PI film, Mitsubishi Gas Chemical's trade name, Neoprim), polycarbonate film (Teijin Chemical's trade name, Pureace T-138 (¼ wavelength plate), Panlite D-92). As the starting material for the organic layer, the monomer used in the sample 3 of the invention was used. The result is shown in Table 2.

As a result of determination of the water vapor permeability of each sample, it is confirmed that the barrier film substrates of the invention have good barrier capability irrespective of the type of the substrate film used therein.

TABLE 2

| | | | Water Vapor |
|---|---|---|---|
| Sample | | Substrate | Permeability |
| No. | Monomer | Film | (g/m²/day) |
| 3-1 | 1,9-nonanediol | Zeonoa ZF-16 | 0.0008 |
| 3-2 | diacrylate/tris | Neoprim | 0.0010 |
| 3-3 | acryloyloxyethyl | Pureace T-138 | 0.0007 |
| 3-4 | phosphate = 3/1 | Panlite D-92 | 0.0008 |

### 5. Production of Barrier Film Substrate (3):

The sample 3 of the invention and the comparative sample 5 were produced in the same manner as above, in which, however, the inorganic layer was changed from aluminum oxide to silicon oxide and was formed in the same manner as in the above process (3-2). The samples were analyzed for the water vapor permeability in the same manner as in the above process (3-4). The density of the silicon oxide film was measured according to an X-ray reflectance measuring method, and was 2.3. The result is shown in Table 3.

As a result of the measurement of the water vapor permeability of the samples, it is confirmed that the barrier film of aluminum oxide is influenced less by the degree of swelling of the underlying organic layer than the barrier film of silicon oxide. Specifically, it is confirmed that the effect of the barrier film substrate produced by the use of the acrylate satisfying the requirement in the invention is more remarkable when the density of the adjacent inorganic layer is higher.

TABLE 3

| | | | Water | |
|---|---|---|---|---|
| | | | Vapor | |
| Sample | | Layer | Permeability | |
| No. | Organic Layer | Constitution | (g/m²/day) | Remarks |
| 8 | 1,9-nonanediol | silicon oxide | 0.005 | the |
| | diacrylate/ | film | | invention |
| | trisacryloyloxy | layer/organic | | |
| | ethyl phosphate = | layer/substrate | | |
| | 3/1 | | | |
| 9 | dimethylol- | silicon oxide | 0.01 | comparative |
| | tricyclo | film | | sample |
| | decane | layer/organic | | |
| | diacrylate | layer/substrate | | |

6. Production and Evaluation of Organic EL device:

### (1) Production of Organic EL Device:

An ITO film-coated conductive glass substrate (surface resistivity, 10 Ω/square) was washed with 2-propanol, and then subjected to UV-ozone treatment for 10 minutes. On this substrate (anode), the following organic compound layers were deposited in order according to a vapor deposition method.

### (First Hole Transportation Layer)

Copper Phthalocyanine thickness 10 nm

### (Second Hole Transportation Layer)

N,N′-diphenyl-N,N′-dinaphthylbenzidine thickness 40 nm

(Light Emission Layer serving also as electron transportation layer)

Tris(8-hydroxyquinolinato)aluminum thickness 60 nm

Finally, lithium fluoride was vapor-deposited in a thickness of 1 nm and metal aluminum was in a thickness of 100 nm in that order, serving as a cathode. On this, a silicon nitride film having a thickness of 5 μm was formed according to a parallel plate CVD method, thereby constructing an organic EL device.

### (2) Disposition of Gas-Barrier Laminate on Organic EL Device (1):

Using a thermosetting adhesive (Daizo-Nichimori's Epotec 310), the organic EL device produced in the above (1) was stuck to the barrier film substrate, sample 3, sample 3-1 or sample 5 (sealing film), and heated at 65° C. for 3 hours to cure the adhesive. Sealed organic EL devices (BOEL-1 to BOEL-3) were thus produced.

### (3) Disposition of Gas-Barrier Laminate on Organic EL Device (2):

Using an organic/inorganic laminate film formation device (Vitex Systems' Guardian 200), the organic EL device produced in the above (1) was sealed up with a barrier laminate (organic/inorganic laminate film). Guardian 200 is a device for producing an organic/inorganic barrier laminate. In this device, an organic layer and an inorganic layer are formed continuously all in vacuum, and therefore, the barrier laminate to be produced therein is not exposed to open air until the completion of its production. The organic layer formation method using this device is flash vapor deposition under an inner pressure of 3 Pa, and the UV irradiation energy for polymerization is 2 J/cm². As the starting material for the organic layer, used was a mixed solution of the acrylate monomer (95 g) used for the sample 3 and a UV polymerization initiator (Esacure TZT, 5g). The inorganic layer is an aluminum oxide film formed according to a reactive sputtering method (in this, the reactive gas is oxygen) with a direct-current pulse given to an aluminum target. The thickness of the formed organic layer was 1500 nm, and that of the formed inorganic layer (aluminum oxide) was 100 nm. The film density was 2.8. In that manner, a barrier laminate-sealed organic EL device BOEL-4 was produced.

TABLE 4

| Organic EL | |
|---|---|
| Device | Sealant |
| BOEL-1 | Sample 3 |
| BOEL-2 | Sample 3-1 |
| BOEL-3 | Sample 5 |
| BOEL-4 | (laminate) |

### (4) Evaluation of Light-Emitting Surface of Organic EL Device:

Immediately after their production, the organic EL devices (BOEL-1 to BOEL-4) were driven for light emission at a voltage of 7V applied thereto, using a current/voltage generator (source measure unit, Keithley's SMU2400 Model). Using a microscope, the surface of each sample was checked for its condition with light emission, and it was confirmed that all the devices gave uniform light emission with no dark spot.

Next, the devices were kept in a dark room at 40° C. and a relative humidity of 90% for 60 days, and checked for the surface condition with light emission. The proportion of the area with light emission of the aged sample to that of the original sample was determined. BOEL-1 was 96%; BOEL-2 was 95%; BOEL-3 was 85%; BOEL-4 was 90%.

The above data confirm that the organic EL device sealed up with the barrier film substrate of the invention and the organic EL device sealed up with the barrier laminate of the invention have excellent wet heat durability.

Flexible organic EL devices were produced in the same manner as in the above, in which, however, the barrier film substrate sample 3 was used in place of the glass substrate and a gas-barrier laminate was installed on the thus-constructed organic EL device; and these were evaluated for the surface condition with light emission, in the same manner as in the above. The proportion of the area with light emission of the aged sample to that of the original sample was 80%.

The barrier film substrate of the invention have high adhesiveness between the organic layer and the inorganic layer constituting it, and has a low water vapor permeability. Accordingly, the barrier film substrate of the invention is useful as a sealant film and as a substitute for conventional glass substrates, and is widely applicable to various industrial products (devices and optical components) such as typically organic EL devices.

While the present invention has been described in detail and with reference to specific embodiments thereof, it will be apparent to one skilled in the art that various changes and modifications can be made therein without departing from the spirit and scope thereof.

The present disclosure relates to the subject matter contained in Japanese Patent Application No. 337415/2007 filed on Dec. 27, 2007 and No. 43378/2008 filed on Feb. 25, 2008, which are expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A barrier laminate comprising at least one organic layer and at least one inorganic layer, wherein the organic layer comprises a cured resin having a degree of swelling with water of less than 0.8% or a cured product of an acrylate and/or a methacrylate having a water absorption of less than 1%.

2. The barrier laminate according to claim 1 wherein the organic layer comprises a cured resin having a degree of swelling with water of less than 0.8%.

3. The barrier laminate according to claim 2, wherein the cured resin is a cured product of an acrylate and/or a methacrylate.

4. The barrier laminate according to claim 1 wherein the organic layer comprises a cured product of an acrylate and/or a methacrylate having a water absorption of less than 1%.

5. The barrier laminate according to claim 4, wherein the cured product of an acrylate and/or a methacrylate has a water absorption of less than 0.5%.

6. The barrier laminate according to claim 4, wherein the acrylate/and or methacrylate is a polyfluoroalkanediol diacrylate or a polyfluoroalkanediol dimethacrylate.

7. The barrier laminate according to claim 1, wherein the inorganic layer has a density of at least 2.0.

8. The barrier laminate according to claim 1, wherein the inorganic layer has a density of at least 2.5.

9. A barrier film substrate produced by providing the barrier laminate of claim 1 on a plastic film.

10. A device comprising the barrier laminate of claim 1.

11. The device according to claim 10 wherein the barrier laminate on a plastic film is used as a substrate.

12. The device according to claim 10 sealed up with the barrier laminate.

13. The device according to claim 10 sealed up with the barrier laminate on a plastic film.

14. The device according to claim 10, which is an electronic device.

15. The device according to claim 10, which is an organic EL device.

16. An optical component comprising the barrier film substrate of claim 9 as a substrate thereof.
